(19) United States
(12) Patent Application Publication
(10) Pub. No.: US 2026/0313690 A1
(43) Pub. Date: Oct. 8, 2026

(54) WINDOWED RECOMMENDATION FOR CO-CR

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Frisco, TX (US); Bilal Sadiq, Plano, TX (US)

(21) Appl. No.: 19/633,784

(22) Filed: Mar. 30, 2026

Related U.S. Application Data
(60) Provisional application No. 63/784,768, filed on Apr. 7, 2025.

(51) Int. Cl. H04W 74/0816; H04W 74/08

(52) U.S. Cl. CPC H04W 74/0816; H04W 74/0891

(57) ABSTRACT

Apparatus and methods for windowed recommendation for coordinated channel recommendation (Co-CR) are provided. In one embodiment, a method for operating a requesting access point (AP) is provided. The method further includes generating a multi-AP coordination (MAPC) element, the MAPC element including a MAPC scheme info field including a coordinated channel recommendation (Co-CR) parameter set field including a Co-CR control field, a recommendation periods info field, and a recommendation timeout field. The method further includes transmitting the MAPC element to a coordinated AP, and determining parameters of a Co-CR agreement based on the Co-CR parameter set field.

### CROSS-REFERENCE TO RELATED APPLICATIONS AND CLAIM OF PRIORITY

This application claims priority under 35 U.S.C. § 119(e) to U.S. Provisional Patent Application No. 63/784,768 filed on Apr. 7, 2025. The above-identified provisional patent application is hereby incorporated by reference in their entirety.

### TECHNICAL FIELD

This disclosure relates generally to wireless networks. More specifically, this disclosure relates to a method and apparatus for a windowed recommendation for coordinated channel recommendation (Co-CR).

### BACKGROUND

Wireless local area network (WLAN) technology allows devices to access the internet in the 2.4 GHz, 5GHz, 6GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

This disclosure provides apparatuses and methods for a windowed recommendation for Co-CR.

In one embodiment, a method for operating a requesting access point (AP) is provided. The method includes generating a multi-AP coordination (MAPC) element, the MAPC element including a MAPC scheme info field including a Co-CR parameter set field including a Co-CR control field, a recommendation periods info field, and a recommendation timeout field. The method further includes transmitting the MAPC element to a coordinated AP, and determining parameters of a Co-CR agreement based on the Co-CR parameter set field.

In another embodiment, a requesting AP includes at least one processor including processing circuitry, and memory storing instructions, wherein the instructions, when executed by the at least one processor individually or collectively, cause the requesting AP to generate a MAPC element, the MAPC element including a MAPC scheme info field including a Co-CR parameter set field including a Co-CR control field, a recommendation periods info field, and a recommendation timeout field. The instructions further include instructions to transmit the MAPC element to a coordinated AP, and determine parameters of a Co-CR agreement based on the Co-CR parameter set field.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example access point (AP) multi-link device (MLD) according to various embodiments of the present disclosure;

FIG. 2B illustrates an example non-AP MLD according to various embodiments of this disclosure;

FIG. 3 illustrates an example of a network where infrastructure traffic and non-infrastructure traffic coexist according to various embodiments of this disclosure;

FIG. 4A illustrates an example format of a Co-CR subelement of a multi-AP coordination (MAPC) element according to embodiments of the present disclosure;

FIG. 4B illustrates an example format of a Co-CR parameter set according to embodiments of the present disclosure;

FIG. 4C illustrates an example format of a control field according to embodiments of the present disclosure;

FIG. 5 illustrates an example format of the recommendation periods info field according to embodiments of the present disclosure; and

FIG. 6 illustrates a flow chart of a method for windowed recommendation for Co-CR according to embodiments of the present disclosure.

### DETAILED DESCRIPTION

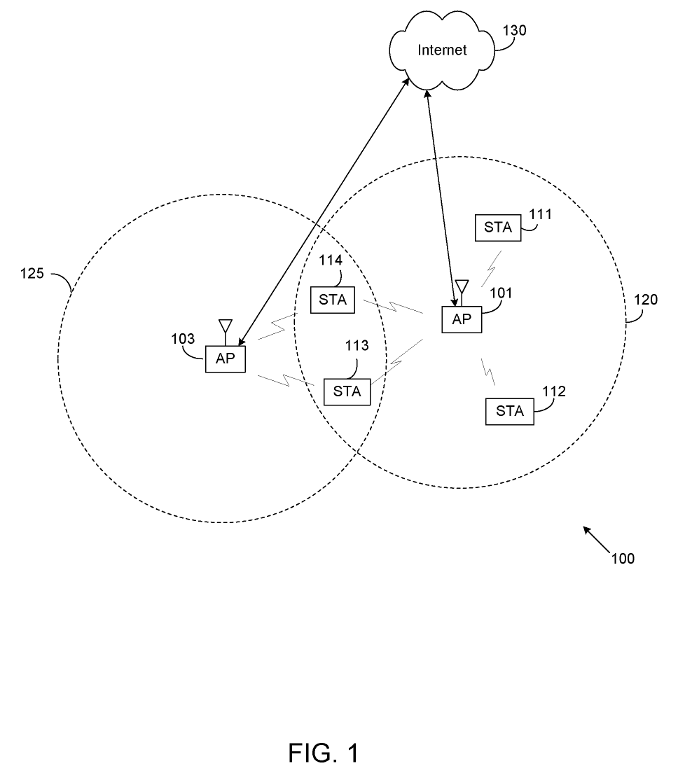

FIGS. 1-6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

The following documents and standards descriptions are hereby incorporated into the present disclosure as if fully set forth herein: [1] IEEE P802.11be –D3.0“Part 11: Wireless LAN Medium Access Control (MAC) and Physical Layer (PHY) Specifications--Amendment 8: Enhancements for extremely high throughput (EHT) and [2] IEEE P802.11REVme –D2.1“Part 11: Wireless LAN Medium Access Control (MAC) and Physical Layer (PHY) Specifications.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for a peer-to-peer (P2P) group trust verification mechanism. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

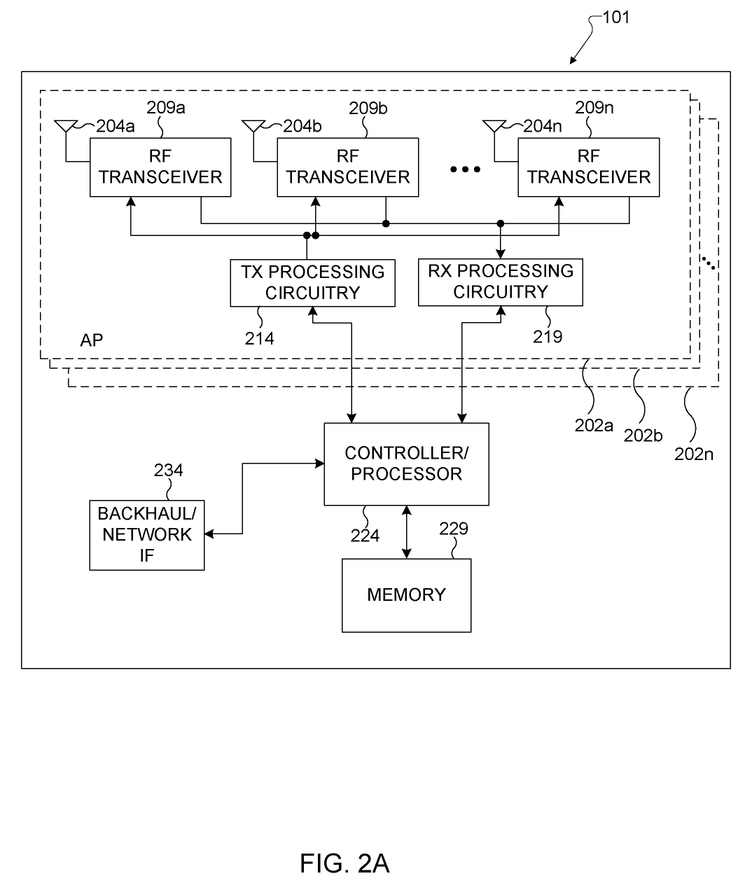

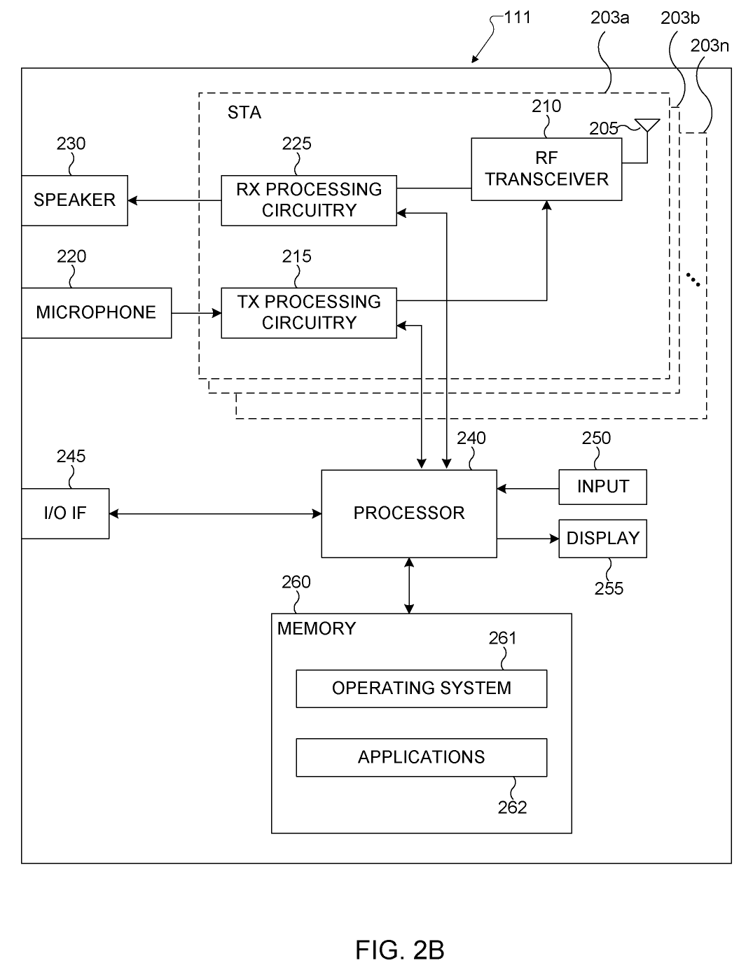

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple radio frequency (RF) transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including a windowed recommendation for Co-CR. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for a windowed recommendation for Co-CR. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate a windowed recommendation Co-CR. In some embodiments, the processor 240 includes at least one microprocessor or microcontroller.

The processor 240 is also capable of executing other processes and programs resident in the memory 260, such as operations for a windowed recommendation for coordinated channel Co-CR. The processor 240 can move data into or out of the memory 260 as required by an executing process. In some embodiments, the processor 240 is configured to execute a plurality of applications 262, such as applications for a windowed recommendation for Co-CR. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted, and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Embodiments of the present disclosure recognize that next generation WLAN system needs to provide better support for low-latency applications. It is not uncommon to observe numerous devices operating on the same network. Many of such devices may be latency-tolerant but still contend with the devices with low-latency applications for the same time and frequency resources. In some cases, the AP as the network controller may not have enough control over the unregulated/unmanaged traffic that contend with the low-latency traffic within the infrastructure BSS. Some of the unmanaged traffic that interfere with the AP’s BSS’ latency sensitive traffic may be coming from uplink (UL)/downlink (DL) or direct link communications within the infrastructure basic set service (BSS) that the AP manages; others may be due to transmission in the neighboring infrastructure BSS (OBSS); yet others may be coming from neighboring independent BSS or P2P networks. The next generation WLAN system needs mechanisms to better handle the unmanaged traffic in order to prioritize the low-latency traffic in the network.

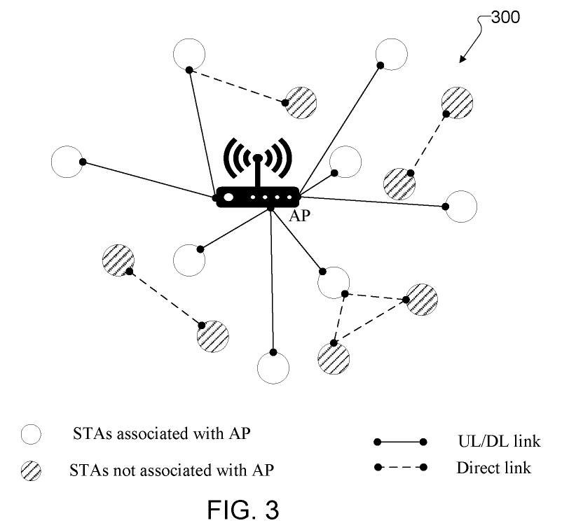

FIG. 3 illustrates an example of a network 300 where infrastructure traffic and non-infrastructure traffic coexist according to various embodiments of this disclosure. The network 300 shown in FIG. 3 is for illustration only. Other embodiments could be used without departing from the scope of this disclosure. P2P communication represents a significant advancement in IEEE 802.11 wireless local area networks (WLANs), commonly known as Wi-Fi. Traditionally, Wi-Fi networks rely on an access point (AP) to mediate communications between devices. In contrast, P2P communication enables direct data transmission between devices without the need for an intermediate AP. This direct communication is facilitated by standards such as Wi-Fi Direct, which allows devices to establish connections and communicate directly, enhancing efficiency and reducing latency.

The concept of P2P groups extends this capability, enabling multiple devices to form a network where each device can communicate directly with every other member of the group. This setup is particularly useful for applications like file sharing, multiplayer gaming, and streaming media within a local network. The formation of such groups typically involves discovery mechanisms that allow devices to identify potential peers and negotiate group membership. Security is paramount in these groups, ensuring that only authorized devices can join and participate.

The benefits of P2P groups are numerous. By eliminating the need for an AP, they reduce latency and conserve battery life on devices. This makes them ideal for scenarios requiring real-time communication or energy efficiency. Additionally, P2P groups enable innovative applications such as smart home systems and IoT networks, where direct device interaction is crucial.

Despite these advantages, challenges exist in managing P2P groups. Coordinating multiple devices without a central AP requires sophisticated mechanisms to allocate resources like bandwidth fairly. Ensuring seamless group management when devices join or leave is also essential to maintain uninterrupted communication.

Standards within the 802.11 family, such as Wi-Fi Direct and potentially other specifications like 802.11z, provide the framework for these P2P capabilities. These standards ensure compatibility and security, often incorporating encryption methods like Wi-Fi protected access (WPA) encryption such as WPA2 or WPA3 to protect data integrity.

In terms of addressing and routing, devices in a P2P group utilize unique identifiers such as MAC addresses to target communications accurately. This ensures that data packets reach their intended destinations without confusion.

While P2P groups operate independently of an AP for data transmission, the role of the AP may still be relevant for initial authentication or resource management, ensuring a smooth and secure communication environment.

In various embodiments, Co-CR is one of the significant features for 802.11bn. However, how an AP can negotiate Co-CR with another AP with time windows for Co-CR is not clear and needs to be defined.

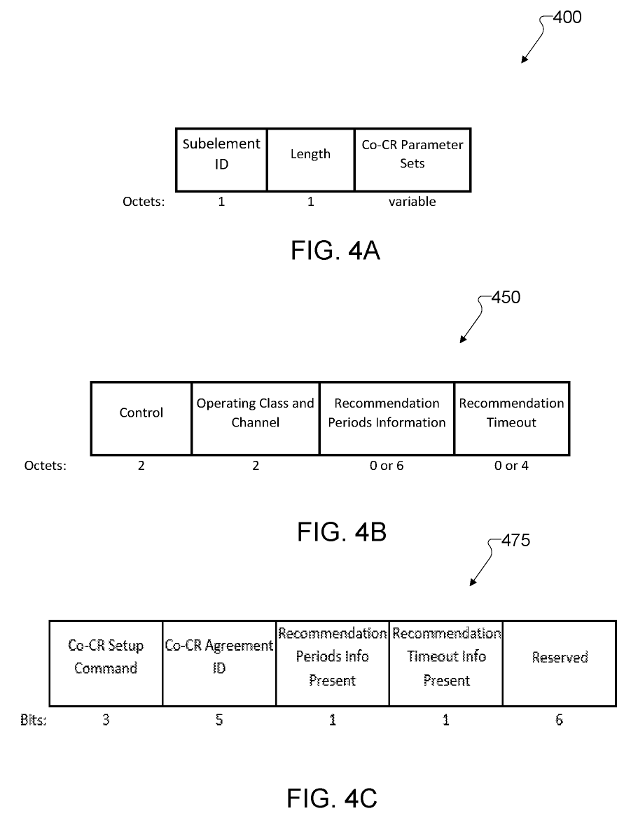

FIG. 4A illustrates an example format of a Co-CR subelement 400 of a multi-AP coordination (MAPC) element according to embodiments of the present disclosure. FIG. 4B illustrates an example format of a Co-CR parameter set 450 according to embodiments of the present disclosure. FIG. 4C illustrates an example format of a control field 475 according to embodiments of the present disclosure. The example format of the Co-CR subelement 400, the example format of the Co-CR parameter set 450, and the format of a control field 475 are for illustration only. Other embodiments could be used without departing from the scope of this disclosure.

As illustrated in FIGS. 4A-4C, the Co-CR subelement 400 includes a subelement ID field, a length field, and a Co-CR parameter sets field. In one or more embodiments, the Co-CR parameter sets field can include a Co-CR parameter set field 450. The Co-CR parameter set field 450 can include the control field 475 (also referred to as a “Co-CR control field 475), the operating class and channel field, a recommendation periods info field, and a recommendation time out field.

In one or more embodiments, a Co-CR requesting AP (also referred to as a coordinated AP) or a Co-CR responding AP (also known as a coordinated AP) that intends to modify an existing Co-CR agreement shall send an MAPC negotiation request frame with a negotiation MAPC element (or MAPC element) included in the MAPC negotiation request frame. The negotiation MAPC element can include the Co-CR parameter set field 450 that includes a Co-CR agreement ID (in the control field 475) field identifying the Co-CR agreement that is to be modified. In one or more embodiments, the control field includes a Co-CR setup command field which can be set to the value 1 instructing to modify the Co-CR agreement. In one or more embodiments, the Co-CR setup command field is a general field. In one or more embodiments, the Co-CR parameter set field 450 further includes an operating class and channel field, recommendation periods info field (if present), and the recommendation timeout field (if present) that can indicate the suggested new set of Co-CR parameters that would replace the existing Co-CR agreement. After the successful reception of the MAPC negotiation request frame, the recipient AP (also referred to as a “coordinated AP”) may respond by sending a MAPC negotiation response frame that includes a negotiation MAPC element including the Co-CR subelement 400 with the Co-CR setup command field value set to indicate acceptance, rejection, or alternate Co-CR parameters (an alternate Co-CR agreement).

In one or more embodiments, the operating class and channel field in the Co-CR subelement 400 can indicate the suggested operating class and the channel that the requesting AP recommends for P2P operation.

In one or more embodiments, the recommendation periods info field (if present) can indicate a set of parameters that describe a series of time windows during which the channel recommendation indicated by the operating class and channel field is valid. The absence of the recommendation periods info field in the Co-CR parameter set field 450 indicates that the corresponding Co-CR channel recommendation is valid at all time instances until the agreement is torn down. As noted above, the Co-CR parameter Sets field may include one or more Co-CR parameter set fields 450.

In one or more embodiments, the operating class and channel field is described in more detail in reference [1].

The recommendation periods info present field in the control field 475 indicates whether or not the recommendation periods info field is present in the Co-CR parameter set field 450. If the recommendation periods info present field is set to 1, then the recommendation periods info field is present in the Co-CR parameter set field 450; otherwise, it is not present.

The recommendation timeout info present field in the control field 475 indicates whether or not the recommendation timeout field is present in the Co-CR parameter set field 450. If the field is set to 1, then the recommendation periods info field is present in the Co-CR parameter set field 450; otherwise, it is not present.

In one or more embodiments, and as noted above, the recommendation timeout field indicates the time until when the channel recommendation corresponding to Co-CR parameter set field is valid. The absence of this field in the Co-CR parameter set field indicates that the recommendation is valid until the agreement is torn down.

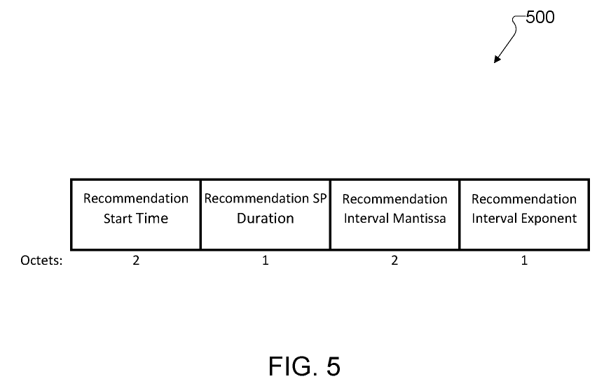

FIG. 5 illustrates an example format of the recommendation periods info field 500 according to embodiments of the present disclosure. The example format of the recommendation periods info field 500 is for illustration only. Other embodiments could be used without departing from the scope of this disclosure.

As illustrated in FIG. 5, the recommendation periods info field 500 includes a recommendation start time field, a recommendation service period (SP) duration field, a recommendation interval mantissa field, and a recommendation interval exponent field.

The recommendation start time field can include a positive unsigned integer corresponding to the a timing synchronization function (TSF) value of the requesting AP indicating the start time of a first Co-CR recommendation SP in a series of SPs included in the Co-CR parameter set field 450. The lowest bit of the recommendation start time field can be set to bit 10 of the corresponding TSF value Co-CR requesting AP.

In one or more embodiments, the recommendation SP duration field indicates the duration of time, in units of TU, during which the Co-CR channel recommendation applies.

In one or more embodiments, the recommendation interval mantissa field is set to the value of the mantissa of the recommendation SP interval value in microseconds, base 2.

In one or more embodiments, the recommendation interval exponent field is set to the value of the exponent of the recommendation SP interval value in microsecond, base 2.

In one or more embodiments, the recommendation timeout field contains an unsigned 32-bit integer, indicating the lifetime of the channel recommendation, in units of TUs.

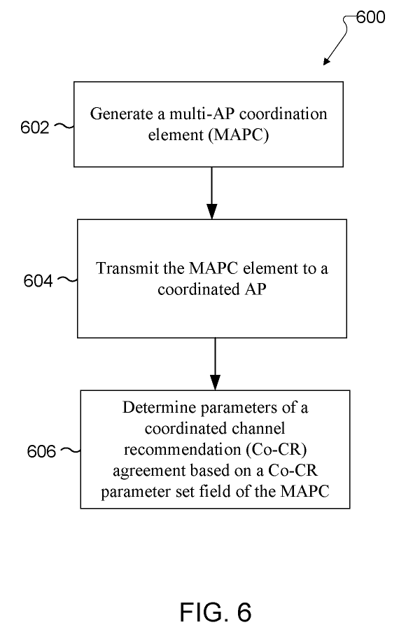

FIG. 6 illustrates a flow chart of a method 600 for windowed recommendation for Co-CR according to embodiments of the present disclosure. The method 600 of FIG. 6 can be performed between any one of the APs 101-103 of FIG. 1, such as AP 101 of FIG. 2A. The method 600 is for illustration only and other embodiments can be used without departing from the scope of the present disclosure.

The method 600 begins with an requesting AP generating an MAPC element (602). The MAPC element, which can be found in reference [1], includes an MAPC scheme info field that includes the Co-CR parameter set field 450. As noted above, the Co-CR parameter set field 450 includes at least the control field 475, a recommendation periods info field, and the recommendation timeout field. As also noted above, the control field 475 includes a recommendation periods info present field and a recommendation timeout field, that each respectively, indicate whether the recommendation periods info field and/or the recommendation timeout field are present in the same manner described above.

In one or more embodiments, the requesting AP transmits the MAPC element to a coordinated AP (604). The requesting AP then determines parameters of a Co-CR agreement between the requesting AP and the coordinated AP (606) in the same manner described above based on the MAPC element.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for operating a requesting access point (AP), the method comprising:
generating a multi-AP coordination (MAPC) element, the MAPC element including a MAPC scheme info field including a coordinated channel recommendation (Co-CR) parameter set field including:
a Co-CR control field;
a recommendation periods info field; and
a recommendation timeout field;
transmitting the MAPC element to a coordinated AP; and
determining parameters of a Co-CR agreement based on the Co-CR parameter set field.

2. The method of claim 1, wherein the Co-CR control field comprises a recommendation periods info present field that indicates that the recommendation periods info field is included in the Co-CR parameter set field.

3. The method of claim 2, wherein the recommendation periods info field comprises:
a recommendation start time field;
a recommendation service period (SP) duration field;
a recommendation interval mantissa field; and
a recommendation interval exponent field.

4. The method of claim 3, wherein the recommendation start time field comprises a positive unsigned integer corresponding to a timing synchronization function (TSF) value of the requesting AP indicating a start time of a first SP of a series of SPs.

5. The method of claim 3, wherein the recommendation SP duration field indicates a duration of time.

6. The method of claim 3, wherein the recommendation interval mantissa field includes a value of a mantissa of an SP value included in the recommendation SP duration field.

7. The method of claim 6, wherein the recommendation interval exponent field includes a value of an exponent of the SP value included in the recommendation SP duration field.

8. The method of claim 1, wherein the Co-CR control field comprises a recommendation timeout info present field that indicates whether a recommendation timeout field is included in the Co-CR parameter set field.

9. The method of claim 8, wherein the recommendation timeout field indicates a lifetime of the Co-CR agreement.

10. The method of claim 9, wherein the recommendation timeout field is an unsigned 32-bit integer.

11. A requesting access point (AP), comprising:
at least one processor including processing circuitry; and
memory storing instructions, wherein the instructions, when executed by the at least one processor individually or collectively, cause the requesting AP to:
generate a multi-AP coordination (MAPC) element, the MAPC element including a MAPC scheme info field including a coordinated channel recommendation (Co-CR) parameter set field including:
a Co-CR control field;
a recommendation periods info field; and
a recommendation timeout field;
transmit the MAPC element to a coordinated AP; and
determine parameters of a Co-CR agreement based on the Co-CR parameter set field.

12. The requesting AP of claim 11, wherein the Co-CR control field comprises a recommendation periods info present field that indicates that the recommendation periods info field is included in the Co-CR parameter set field.

13. The requesting AP of claim 12, wherein the recommendation periods info field comprises:
a recommendation start time field;
a recommendation service period (SP) duration field;
a recommendation interval mantissa field; and
a recommendation interval exponent field.

14. The requesting AP of claim 13, wherein the recommendation start time field comprises a positive unsigned integer corresponding to a timing synchronization function (TSF) value of the requesting AP indicating a start time of a first SP of a series of SPs.

15. The requesting AP of claim 13, wherein the recommendation SP duration field indicates a duration of time.

16. The requesting AP of claim 13, wherein the recommendation interval mantissa field includes a value of a mantissa of an SP value included in the recommendation SP duration field.

17. The requesting AP of claim 16, wherein the recommendation interval exponent field includes a value of an exponent of the SP value included in the recommendation SP duration field.

18. The requesting AP of claim 11, wherein the Co-CR control field comprises a recommendation timeout info present field that indicates whether a recommendation timeout field is included in the Co-CR parameter set field.

19. The requesting AP of claim 18, wherein the recommendation timeout field indicates a lifetime of the Co-CR agreement.

20. The requesting AP of claim 19, wherein the recommendation timeout field is an unsigned 32-bit integer.
